(19) United States
(12) Patent Application Publication
(10) Pub. No.: US 2006/0033867 A1
(43) Pub. Date: Feb. 16, 2006

(54) LCD mirror system and method

(76) Inventors: Annette J. Krisko, (US); Gary L. Pfaff, (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/201,174

(22) Filed: Aug. 10, 2005

Related U.S. Application Data
(60) Provisional application No. 60/600,423, filed on Aug. 10, 2004.

(51) Int. Cl. G02F 1/1335

(52) U.S. Cl. 349/113

(57) ABSTRACT

Embodiments of the invention include a LCD having a mirror including a substrate having a first surface and a second surface. The substrate may carry one or more dichroic mirror coatings and the LCD or mirror may be selectively viewable from the first surface side. Embodiments of the invention also include methods of making and using a LCD mirror.

### RELATED APPLICATIONS

This application claims priority to U.S. Provisional Application No. 60/600,423, titled “LCD Mirror System and Method”, filed Aug. 10, 2004, the contents of which are hereby incorporated by reference.

### FIELD OF THE INVENTION

The present invention relates to a liquid crystal display. Additionally, the present invention relates to liquid crystal displays that include a dichroic mirror, which function as an operable mirror when the liquid crystal display is switched off.

### BACKGROUND OF THE INVENTION

There is a trend in the marketplace to provide options to conceal electronic equipment, such as liquid crystal displays (LCDs). One such concealment option is to provide a LCD hidden behind a mirror, the LCD being selectively viewable by switching it on or off. Unfortunately, presently available products do not provide an ideal mirror-type image when the LCD is turned off, and/or do not clearly transmit the LCD image through the mirror when the LCD is turned on.

### SUMMARY OF THE INVENTION

Embodiments of the invention include a liquid crystal display (LCD) comprising a mirror including a substrate having a first surface and a second surface and carrying one or more dichroic mirror coatings, the LCD or mirror being selectively viewable from the first surface side. Other embodiments of the invention include a LCD comprising a mirror including a substrate having a first surface and a second surface and carrying one or more dichroic mirror coatings including a base layer and a metal oxide film layer and one or more functional coatings. Embodiments of the invention also include a method of making a LCD. Such embodiments are useful for providing a high quality mirror when the LCD is turned off and for providing a high quality image when the LCD is turned on.

### BRIEF DESCRIPTION OF THE DRAWINGS

FIG. 1(a) is a side view of an embodiment of a LCD mirror in accordance with an embodiment of the present invention.

FIG. 1(b) is a side view of an embodiment of a LCD mirror in accordance with an embodiment of the present invention.

FIG. 2 is a front view of an embodiment of a LCD mirror in accordance with an embodiment of the present invention.

FIG. 3 is a side view of a dichroic mirror coating in accordance with an embodiment of the present invention.

FIG. 4 is a side view of an embodiment of a functional coating in accordance with an embodiment of the present invention.

FIG. 5 is a side view of an embodiment of a functional coating in accordance with an embodiment of the present invention.

FIG. 6 is a schematic illustration of a dual direction sputtering chamber in accordance with an embodiment of the present invention.

### DETAILED DESCRIPTION OF THE INVENTION

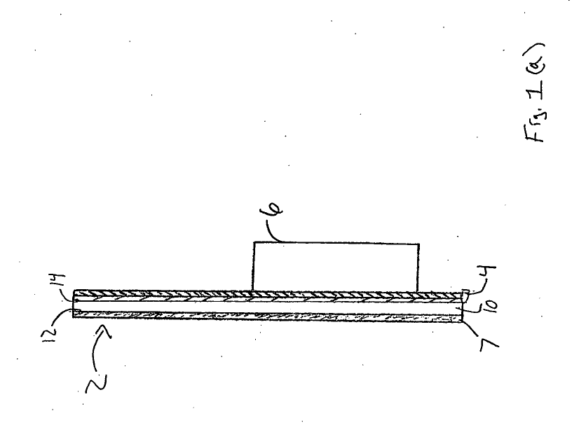

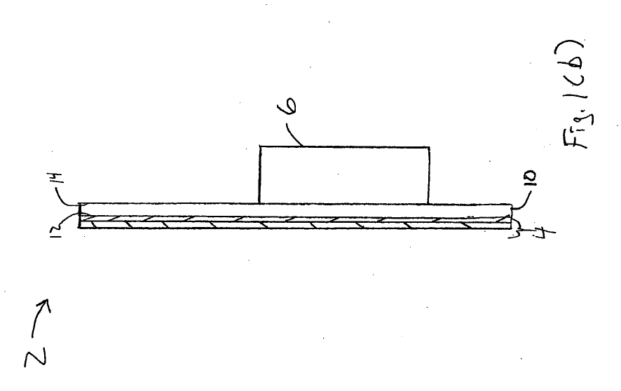

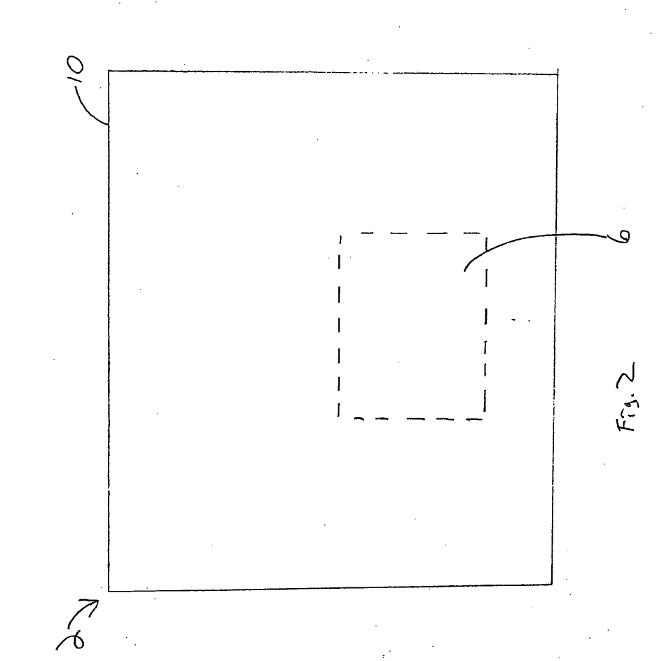

The present invention provides a liquid crystal display (LCD) mirror 2 comprising a dichroic mirror coating 4, a LCD 6, and, optionally, one or more functional coatings 7, as shown in FIGS. 1(a), 1(b), and 2. The dichroic coating 4 provides a surprisingly advantageous mirror for LCD products. Although a reflective metal such as chromium or silver may be employed as a reflective film for standard mirrors, dichroic mirrors commonly employ two contiguous films or films of materials having different refractive indices, and reflection occurs at the interface of these films. Dichroic mirrors are discussed in U.S. Pat. No. 6,292,302, the contents of which are herein incorporated by reference. Such a mirror provides a desirable mirror-type image when the LCD is turned off, and clearly transmits the LCD image through the mirror when the LCD is turned on.

The LCD mirror 2 includes a substrate 10. A variety of substrates are suitable for use in the invention. In various embodiments, the substrate 10 is a sheet-like substrate having generally or substantially opposed exterior face 12 (sometimes referred to herein as a first surface) and interior face 14 (sometimes referred to herein as a second surface). The first and second surfaces of the substrate are generally major surfaces. (The designation of “interior” and “exterior” face in the ensuing discussion is somewhat arbitrary. It is assumed, though, that in most circumstances the exterior face will be exposed to an ambient environment wherein it may come into contact with dirt, water and the like.)

In many embodiments, the substrate is a sheet of transparent material (i.e., a transparent sheet). The substrate, however, is not required to be transparent. For most applications, though, the substrate will comprise a transparent (or at least translucent) material, such as glass or clear plastic. For example, the substrate 10 is a glass sheet in various embodiments. A variety of known glass types can be used, and soda-lime glass is expected to be utilized in many cases.

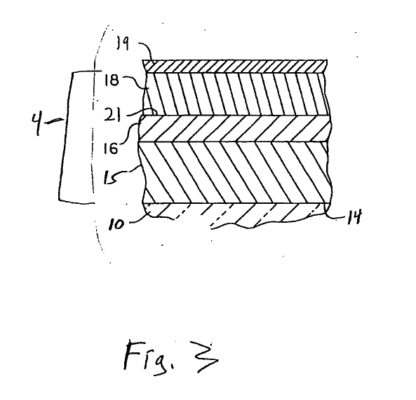

The dichroic mirror coating 4 may be carried on the first surface 12 of substrate 10, as shown in FIG. 1(b), or on the second surface 14, as shown in FIG. 1(a). As shown in FIG. 3, the dichroic mirror coating 4 may include a base film 15 provided on the substrate 10. The base film 15 may increase overall reflectance of the mirror and permit adjustment in color to desirably obtain color neutrality in reflectance. In one useful embodiment, the base film 15 comprises zinc oxide sputtered onto the glass from a zinc target in an oxygen-containing atmosphere. In another embodiment, the base film 15 instead comprises silicon nitride sputtered onto the glass from a silicon target in a nitrogen-containing atmosphere. The silicon target, of course, can comprise a small amount of aluminum or another electrically-conductive material.

Sputtered onto the base film 15 is a metal oxide film 16, followed by an oxidizable element-containing film 18, followed in turn by an optional overcoat 19. The indices of refraction of the films 16 and 18, shown as a contiguous film pair, are sufficiently disparate so that the interface 21 between the two films becomes a reflecting surface. In various embodiments, the indices differ by at least 0.2 (that is, by at least about 10%) and in some embodiments, differ by at least about 0.4 (that is, by at least about 20%). Optional film 19 has as its primary purpose the protection of the film 18 from becoming oxidized when subjected to any elevated temperatures. Oxidation of the film 18 would cause substantial reduction in the reflectivity of the mirror, and oxidation of this film hence should be avoided.

Base film 15 may be of any dielectric material, including zinc oxide, tin oxide, niobium oxide, silicon nitride, bismuth oxide, aluminum oxide, and oxides or nitrides of alloys of these metals. Zinc oxide and oxides of zinc alloys, such as zinc/tin oxide, are useful in that they are in general easy and relatively inexpensive to sputter at significant thicknesses. In one embodiment, though, the base film 15 is formed of silicon nitride. The silicon nitride base coat can be sputtered onto the glass substrate surface (e.g., after cleaning such surface) using magnetron sputtering equipment of the type commercially available from Von Ardenne Coating Technology (Fairfield, Calif., U.S.A.) or Leybold Vacuum (Cologne, Germany).

If the base film 15 is to be formed of zinc oxide, it may be applied using a metallic zinc target in a reactive atmosphere containing oxygen gas. Zinc oxide having a thickness in the range of about 800 angstroms to about 1300 angstroms is utilized in various embodiments of the present invention, and a zinc oxide film having a thickness of about 1095 angstroms has given acceptable results. In other embodiments, silicon nitride is instead employed. This base film 15 can be applied using a silicon target in a reactive atmosphere containing nitrogen gas. Silicon nitride having a thickness in the range of about 50 angstroms to about 1500 angstroms may be utilized.

In various embodiments of the present invention, film 16, which is different from film 15 and which generally forms with the base film 15 a contiguous film pair having disparate refractive indices, comprises an oxide of a metal such as titanium, zinc, niobium, tin and bismuth, with titanium oxide being used in many embodiments. To retard the formation of haze in this film, it is optional to incorporate in this film a small amount of a different material, which may be thought of as an impurity. Nitrogen may be utilized for this purpose, and is readily incorporated in the oxide film by sputtering the metal of that film in an atmosphere that contains a small amount of nitrogen, i.e., not more than about 10 mole percent of nitrogen. In this manner, a titanium oxide film containing a small amount of nitrogen can be produced by sputtering a titanium target in an atmosphere containing, as reactive gasses, a relatively large quantity of oxygen and a relatively small quantity of nitrogen. Desirably, the target is of titanium oxide that is substoichiometric in oxygen. Targets of this type are described in International Application WO 97/25451, published Jul. 17, 1997, the teachings of which are incorporated herein by reference. Here, the target is fabricated by plasma spraying TiO.sub.2 onto a target base in an atmosphere such as argon which is oxygen deficient and which contains no oxygen-containing compounds. When employed in a magnetron sputtering procedure, this target (i.e., a high rate titania target) is able to run at high power levels, leading to the rapid and hence economical deposition of titanium oxide on the glass substrate.

The relative quantities of oxygen and nitrogen or other reactive gas can optionally be adjusted so that the film 16 contains a major proportion of the metal oxide and a minor proportion of another material (e.g., a desired compound) sufficient to retard haze formation during any heat treatment. For example, it is thought that nitrogen can be incorporated interstitially (in grain boundaries) or substitutionally (in titanium oxide crystals) or both. In some embodiments, the mole ratio of the different material, when provided, (nitrogen bound to oxygen and/or titanium, in this example) to the metal oxide (exemplified as titanium oxide) is in the range of about 0.001 to about 0.1. Film 16 can be of any convenient thickness, but, in various embodiments, has a thickness in the range of about 100 to about 500 angstroms.

In various embodiments, contiguous to (that is, touching) the film 16 in FIG. 2 is a film 18 comprising a metal, or a semi-metal such as silicon, the films 16 and 18 forming a contiguous film pair having disparate indices of refraction so as to create a reflective interface 21. Such metals and non-metals tend to be oxidizable, and may be selected from the group consisting of silicon, niobium, aluminum, nickel, chromium, and alloys or other compounds thereof; silicon being used in many embodiments of the present invention, and film 18 in many embodiments has an index of refraction not less than about 1.3 and in some embodiments at least 3.0. Film 18, and the other films contributing to reflectivity, should generally be of thicknesses exceeding their depletion widths, that is, of sufficient thicknesses so that further thickness increase yields substantially no change in refractive index. In some embodiments, film 18 has a thickness of between 50 angstroms and 300 angstroms. The thickness of this layer will depend, at least in part, on the thickness of the lower layers 15 and 16. For instance, if the base film 15 comprises ZnO applied at about 1100 angstroms and film 16 is about 270 angstroms of TiO.sub.2, silicon at about 50-150 angstroms has been found to suffice; if the base film 15 is on the order of 1150 angstroms and the titania in the next layer 16 is decreased to about 230 angstroms, it is preferred that film 18 (e.g., which can be a layer of silicon) be increased to 175-275 angstroms.

In some embodiments, the dichroic mirror coating 4 may include a reflectance enhancing film (not shown) deposited over the film 18 (or over the optional overcoat 19). Such a film is useful for increasing the reflectance of the mirror while still allowing the LCD image to transmit through the coating when the LCD is turned on. In addition, the film can help to naturalize the color reflected by the mirror. The reflectance enhancing film may comprise any material that increases the reflectance of the mirror and allows the LCD image to transmit through it when desired. In some embodiments, the reflectance enhancing film includes niobium-titanium. The niobium-titanium material can be any compound that includes at least some niobium and at least some titanium. In various embodiments, a film of this nature can be deposited by any method described in U.S. patent application Ser. No. 10/123,032, the entire contents of which are incorporated herein by reference.

The resulting dichroic mirror will generally exhibit a transmittance of at least 10% and, in various embodiments, at least 15% (e.g., between about 16% and about 20%), and a film-side reflectance of at least 45% and, in various embodiments, at least 55% (e.g., between about 56% and about 60%). The mirror exhibits haze not greater than about 1% and, in various embodiments, not greater than 0.5%.

Such a dichroic mirror is particularly advantageous when used with a LCD 6. Such a mirror provides for a quality mirror image when the LCD is not in use. When the LCD 6 is turned on, the dichroic mirror transmits a clear and bright image that can be viewed from the reflective side of the mirror. The dichroic mirror provides surprising advantages over other types of mirrors for use with a LCD 6 because it provides superior selective reflectance and transmittance properties over other types of mirrors (e.g., traditional silver backed mirrors). The present invention can be used with any LCD, and the LCD can be functionally coupled to the mirror by any suitable method.

A general discussion of LCDs follows, but is not intended to limit the scope of LCDs that may be utilized. In the simplest form, a LCD comprises a mirror, a piece of glass with a polarizing film on the bottom side, and a common electrode plane comprising, e.g., indium-tin oxide on top. A common electrode plane may cover the entire area of the LCD. The LCD also comprises a layer of liquid crystal substance. The next layer may be another piece of glass with an electrode in the shape of the rectangle on the bottom and, on top, another polarizing film at a right angle to the first one.

The electrode is hooked up to a power source, such as a battery. When there is no current, light entering through the front of the LCD will simply hit the mirror and bounce back out. When the power source supplies current to the electrodes, the liquid crystals between the common-plane electrode and the electrode shaped like a rectangle untwist and block the light in that region from passing through. The LCD shows the rectangle as a black area.

This simple LCD requires an external light source, as liquid crystal materials emit no light of their own. Small and inexpensive LCDs are often reflective, which means to display anything they must reflect light from external light sources. For example, in a LCD watch, the numbers appear where small electrodes charge the liquid crystals and make the layers untwist so that light is not transmitting through the polarized film.

Many computer displays are lit with built-in fluorescent tubes above, beside and sometimes behind the LCD. A white diffusion panel behind the LCD may redirect and scatter the light evenly to ensure a uniform display. Much of this light may be lost on its way through filters, liquid crystal layers, and electrode layers.

Common-plane-based LCDs are good for simple displays that need to show the same information in a repetitive fashion. Although the hexagonal bar shape is the most common form of electrode arrangement in such devices, almost any shape is possible.

Passive matrix and active matrix are two main types of LCDs used in more sophisticated LCD systems. Passive-matrix LCDs use a simple grid to supply the charge to a particular pixel on the display. The grid may comprise two substrates, such as glass sheets. One substrate is given columns and the other is given rows made from a transparent conductive material, such as indium-tin oxide. The rows or columns are connected to integrated circuits that control when a charge is sent down a particular column or row. The liquid crystal material is sandwiched between the two glass substrates, and a polarizing film is added to the outer side of each substrate. To turn on a pixel, the integrated circuit sends a charge down the correct column of one substrate and a ground activated on the correct row of the other. The row and column intersect at the designated pixel, and that delivers the voltage to untwist the liquid crystals at that pixel.

Active-matrix LCDs may comprise thin film transistors (TFT). Generally, TFTs are small switching transistors and capacitors. They are arranged in a matrix on a glass substrate. To address a particular pixel, the proper row is switched on, and then a charge is sent down the correct column. Since all of the other rows that the column intersects are turned off, only the capacitor at the designated pixel receives a charge. The capacitor is able to hold the charge until the next refresh cycle. If the amount of voltage supplied to a crystal is carefully controlled, it will untwist only enough to allow some light through. By doing this in very exact, very small increments, LCDs can create a gray scale. Most displays today offer 256 levels of brightness per pixel.

A LCD that can show colors may include three subpixels with red, green and blue color filters to create each color pixel. Through the careful control and variation of the voltage applied, the intensity of each subpixel can range over 256 shades. Combining the subpixels produces a possible palette of 16.8 million colors (256 shades of red×256 shades of green×256 shades of blue).

LCD technology is constantly evolving. LCDs today employ several variations of liquid crystal technology, including super twisted nematics (STN), dual scan twisted nematics (DSTN), ferroelectric liquid crystal (FLC) and surface stabilized ferroelectric liquid crystal (SSFLC), all of which are compatible with the present invention.

A LCD mirror 2 of the present invention is also well suited for a method of providing advertising. In such a method, advertising images, including still pictures and/or motion pictures, may be shown through a LCD mirror 2. An advertising image is any image intended to promote (e.g., sell) one or more goods and/or services. The LCD mirror 2 may be located in a relatively high traffic area, such as a public concourse, elevator lobby, or bathroom, that will allow the advertising to be viewed by a desirable number of people.

In some embodiments, the LCD mirror is provided with one or more functional coatings 7, as shown in FIGS. 1(a), 4, and 5. The inclusion of functional coating 7 is particularly suitable when dichroic mirror coating 4 is carried on second surface 14 of substrate 10. Functional coating 7 may provide water-sheeting and/or self-cleaning properties (e.g., hydrophilicity and/or photoactivity). Such an embodiment of a LCD mirror may be particularly desirable for applications in which the LCD mirror is to be used in an environment where it will come into contact with water and/or organic contaminants, such as in a bathroom.

Glass surfaces can become “dirty” or “soiled” in a variety of ways. Two of the primary manners in which glass can collect dirt involve the action of water on the glass surface. First, the water itself can deposit or collect dirt, minerals or the like onto the surface of the glass. Obviously, dirty water landing on the glass will leave the entrained or dissolved dirt on the glass upon drying. Even if relatively clean water lands on the exterior surface of the glass, each water droplet sitting on the glass will tend to collect dust and other airborne particles as it dries. These particles and any other chemicals which become dissolved in the water will become more concentrated over time, leaving a characteristic spot or drying ring on the glass surface.

The second way in which water tends to give a glass surface a soiled or less attractive appearance is tied to an attack on the glass surface itself. As a droplet of even relatively clean water sits on a glass surface, it will begin to leach alkaline components from the glass. For a typical soda lime glass, the soda and lime will be leached out of the glass, increasing the pH of the droplet. As the pH increases, the attack on the glass surface will become more aggressive. As a result, the glass which underlies a drying water droplet will become a little bit rougher by the time the water droplet completely dries. In addition, the alkaline components which were leached out of the glass will be redeposited on the glass surface as a drying ring. This dried alkaline material not only detracts from the appearance of the glass; it will also tend to go back into solution when the glass surface is wetted again, rapidly increasing the pH of the next water droplet to coalesce on the glass surface.

In some embodiments, the present invention provides a LCD mirror which has a water-sheeting coating 20. Water sheeting coatings are discussed in U.S. Pat. No. 6,660,365, the contents of which are herein incorporated by reference. An exemplary water-sheeting coating 20 comprises sputtered silica (e.g., SiO₂ sputtered directly onto an exterior surface of the glass). In some embodiments, the water-sheeting coating 20 may have an exterior face which is substantially non-porous, but which has an irregular surface. The optional water-sheeting coating 20 desirably reduces the wetting angle of water on the coated surface of the glass article to below about 25 degrees and causes water applied to the coated surface of the glass article to sheet.

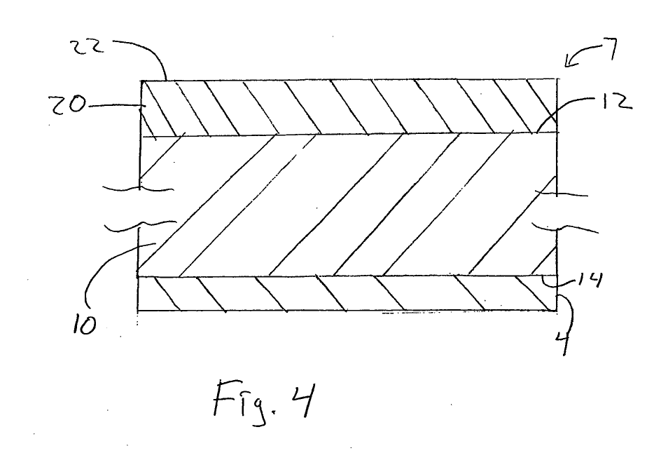

FIG. 4 schematically illustrates a sheet of glass bearing a pair of coatings in accordance with one useful embodiment of the invention. The sheet of glass 10 includes an exterior face (or “major surface”) 12 and an interior face 14. In FIG. 4, the interior face 14 of the glass 10 bears a dichroic coating 4, such as the coatings described above.

The optional water-sheeting coating 20, when provided, can optionally be applied directly to the surface of the glass sheet 12. This may be performed when the water-sheeting coating 20 consists essentially of silica (e.g., SiO₂). The glass will typically be a soda/lime glass, which is largely formed of silica. Depositing a silica water-sheeting coating directly onto glass is believed to provide a strong bond and may enhance the water-sheeting performance of the coating 20.

Thus, the optional water-sheeting coating 20 may comprise silica deposited directly on the exterior surface 12 of the glass 10. The exterior face 22 of coating 20, in various embodiments, is substantially non-porous but has an irregular surface. Accordingly, attributing any specific thickness to this coating 20 will be inherently somewhat inaccurate. However, the coating 20, in some embodiments, has a median thickness of between about 15 angstroms and about 350 angstroms, with a range of between about 15 angstroms and about 150 angstroms being utilized in some embodiments. In some embodiments, the major benefit of this coating at the least cost is believed to be evidenced at a range of about 20 angstroms to about 120 angstroms.

Another functional coating 7, such as a photocatalytic coating, may additionally or alternatively be applied to the LCD mirror. As is known in the art, certain metal oxides absorb ultraviolet light and photocatalytically break down biological materials such as oil, plant matter, fats and greases, etc. The most powerful of these photocatalytic metal oxides appears to be titanium dioxide, though other metal oxides which appear to have this photocatalytic effect include oxides of iron, silver, copper, tungsten, aluminum, zinc, strontium, palladium, gold, platinum, nickel and cobalt.

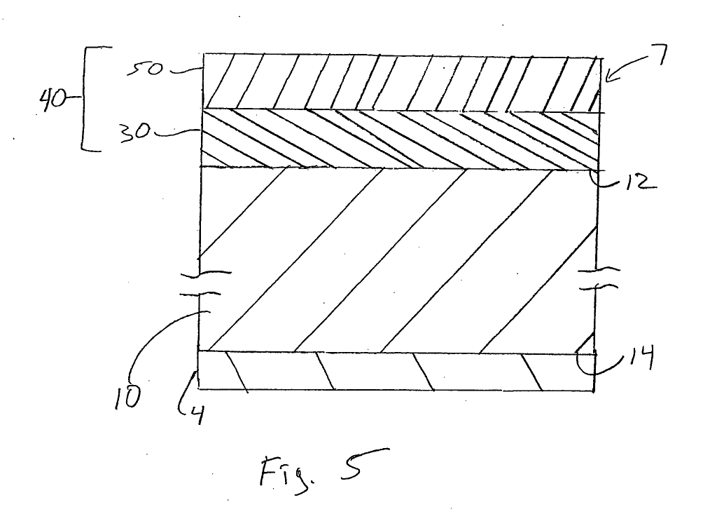

As shown in FIG. 5, certain embodiments of the invention provide a substrate 10 bearing a photocatalytic coating 40. In various embodiments, the coating 40 is over (e.g., the entirely of) an exterior surface 12 of the substrate 10. In some embodiments, the coating 40, when provided, includes at least one photocatalytic film (e.g., comprising, consisting essentially of, or consisting of titania). In one embodiment, the coating 40 includes two films: (1) a first film 30 deposited over an exterior surface 12 of the substrate 10; and (2) a second film 50 deposited over the first film 30. As shown in FIG. 5, interior surface 14 may include a dichroic coating 4, such as the coatings described above.

In various embodiments of the present invention, the first film 30 includes a base film, such as silica (e.g., silicon dioxide), and desirably is deposited directly over the substrate 10 (e.g., directly over an exterior surface 12 of the substrate). This film generally consists of, or consists essentially of, silicon dioxide. The silica in the first film 30, however, can include small amounts of an electrically-conductive material, such as aluminum, which may be oxidized in the film 30. For example, this film 30 can be deposited by sputtering a silicon-containing target that includes a small amount of aluminum or another metal that enhances the electrical conductivity of the target. The first film 30 may have (e.g., is deposited at) a physical thickness of less than about 300 angstroms, alternatively less than about 150 angstroms and further alternatively about 70 angstroms to about 120 angstroms.

The coating 40 includes a second film 50 comprising a photocatalyst, such as titania (e.g., TiO₂). The second film 50 can optionally be deposited directly over the first film 30. Alternatively, another film (e.g., comprising, consisting essentially of, or consisting of zirconia) can be provided between films 30 and 50. It is noted that one or more photocatalytic materials can be used as the second film 50, including but not limited to oxides of titanium, iron, silver, copper, tungsten, aluminum, zinc, strontium, palladium, gold, platinum, nickel, cobalt and combinations thereof. In various embodiments, the second film 50 consists of, or consists essentially of, titanium dioxide. In some embodiments though, the second film 50 consists of, or consists essentially of, substoichiometric titanium oxide (TiOₓ, where x is less than 2). In various embodiments, the second film 50 has (e.g., is deposited at) a physical thickness of less than about 300 angstroms, alternatively less than about 150 angstroms and further alternatively between about 30 angstroms and about 120 angstroms.

Thus, certain embodiments provide a LCD mirror with a substrate 10 (e.g., a glass sheet) having an exterior surface 12 over which (e.g. directly over) is deposited a first film 30 consisting essentially of silicon dioxide at a thickness of between about 70 angstroms and about 120 angstroms, wherein a second film 50 consisting essentially of titanium oxide is deposited directly over the first film 30 at a thickness of between about 30 angstroms and about 300 angstroms. In some embodiments of this nature, the first film 30 has a thickness of between about 70 angstroms and about 120 angstroms, perhaps optimally about 100 angstroms, while the second film 50 has a thickness of between about 40 angstroms and about 150 angstroms, perhaps optimally about 100 angstroms. In some cases, the thickness of the second film 50 is less than 100 angstroms, and in some embodiments, less than about 90 angstroms, but greater than 30 angstroms (e.g., about 50-75 angstroms).

The coatings of the LCD mirror can be deposited by any suitable method, as is well understood in the art. In some embodiments, the coatings are deposited by magnetron sputtering techniques. Magnetron sputtering chambers are well known in the art and are commercially available from a variety of sources. While a thorough discussion of magnetron sputtering chambers is beyond the scope of the present disclosure, one useful structure for such a device is disclosed in U.S. Pat. No.4,166,018 (Chapin), the teachings of which are incorporated herein by reference.

Generally speaking, though, magnetron sputtering involves providing a target formed of a metal or dielectric which is to be deposited on the substrate. This target is provided with a negative charge and a relatively positively charged anode is positioned adjacent the target. By introducing a relatively small amount of a desired gas into the chamber adjacent the target, a plasma of that gas can be established. Atoms in this plasma will collide with the target, knocking the target material off of the target and sputtering it onto the substrate to be coated. It is also known in the art to include a magnet behind the target to help shape the plasma and focus the plasma in an area adjacent the surface of the target.

In some embodiments of the invention, coatings are applied to both sides of the substrate via a sputter-up/sputter-down technique. Useful sputter-up/sputter-down techniques are discussed in U.S. Pat. No. 6,660,365, the entire contents of which are incorporated herein by reference. In one embodiment, the method comprises first providing a sheet of glass having an interior surface and an exterior surface. The interior and exterior surfaces of the glass are optionally cleaned. Thereafter, in some embodiments, the interior surface of the sheet of glass is coated with a dichroic mirror coating by sputtering, in sequence, at least one base layer (e.g., comprising silicon nitride), at least one metal or metal oxide (e.g., comprising titanium oxide), and optionally at least one protective overcoat layer (e.g., comprising silicon). The exterior surface of the glass is optionally coated with a functional coating, such as a water-sheeting coating. In some embodiments, this involves sputtering silica directly onto the exterior surface of the sheet of glass. In one embodiment, the exterior surface is coated with a photocatalytic coating by sputtering, in sequence, a base layer (e.g., comprising silica) and a photocatalytic film (e.g, comprising titania). If so desired, a water-sheeting coating and/or a photocatalytic coating can be applied to the substrate using the same sputter coating apparatus that is used to deposit the dichroic mirror coating on the substrate. With appropriate material selection, the water-sheeting coating and/or photocatalytic coating and one of the dichroic mirror layers can even be applied in the same sputtering chamber (e.g., in a shared oxidizing atmosphere). If so desired, the substrate can be coated on both the interior surface and the exterior surface while maintaining the glass in a constant (e.g., horizontal) orientation, such as, for example, wherein the interior surface is positioned above the exterior surface.

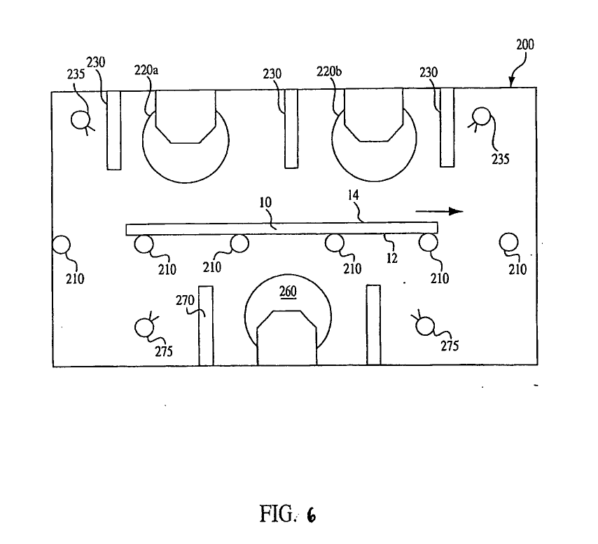

FIG. 6 schematically illustrates a dual direction sputtering chamber in accordance with one embodiment of the present invention. In FIG. 6, the sheet of glass 10 to be coated is positioned on a plurality of support rollers 210 which are spaced along the length of the sputtering chamber 200. While the precise spacing of these rollers 210 can be varied, for reasons explained more fully below, it is desired that these rollers are spaced a little bit farther apart along at least an interim length of the chamber 200 to increase the effective coating area from the lower target 260.

In the illustrated embodiment, the sheet of glass 10 is oriented to travel horizontally across these rollers, e.g., from left to right. The interior surface 14 of the glass is oriented upwardly while the exterior surface 12 of the glass is oriented downwardly to rest on the rollers 210. (While this is probably the most typical configuration, it should be understood that the relative orientation of the glass within the sputtering chamber 200 can be switched so long as the relative positions of the upper targets 200 and the lower target 260 are also reversed. As a consequence, it should be noted that designating these targets as “upper” and “lower” targets is simply for purposes of convenience and the relative orientation of these elements within the sputtering chamber can easily be reversed if so desired.)

The sputtering chamber 200 shown in FIG. 6 includes two spaced-apart upper sputtering targets 220a and 220b. While these targets can be planar targets, they are illustrated as being so-called rotary or cylindrical targets. These targets are arranged generally parallel to one another, optionally with a plurality of anodes 230 extending horizontally and generally parallel to these targets. As suggested in U.S. Pat. No. 5,645,699, the entire contents of which are incorporated herein by reference, an intermediate anode 230 can optionally be positioned between these two targets.

A gas distribution system is used to supply the sputtering gas to the chamber adjacent the targets 220a and 220b. While a variety of gas distribution systems are known in the art, this distribution system can simply comprise a pair of pipes 235 with a plurality of spaced-apart openings or nozzles oriented generally toward the target.

The sputtering chamber 200 also includes a “lower” target 260. This target can be used to sputter the optional functional coating(s), such as the functional coatings described above, on the exterior surface 12 of the glass. As with the upper targets 220a and 220b, the lower target 260 can optionally be provided with at least one, and, in some embodiments, two anodes 270 in sufficient proximity to establish a stable plasma. The gas distribution pipes 235 shown adjacent the upper targets 220a and 220b are undesirably far from the lower target 260 and the intermittent presence of the glass 10 may effectively divide the sputtering chamber 200 into two separate functional areas. In various embodiments, it is preferred to have separate gas distribution pipes 275 positioned beneath the gas adjacent the lower target 260 to ensure a consistent supply of gas for the plasma adjacent the target. If so desired, the lower pipes 275 and the upper pipes 235 can be a part of the same gas distribution system, i.e., both sets of pipes can be connected to a single gas supply.

The following examples are illustrative only and are not intended to limit the scope of the invention:

### EXAMPLE 1

### Dichroic Mirror Coating

| Si₃N₄ | TiO₂ | Si | | | | |
|---|---|---|---|---|---|---|
| (Angstroms) | (Angstroms) | (Angstroms) | T (%) | Rf (%) | a | b |
| 280 | 280 | 253 | 18 | 54 | 0.7 | 3.5 |

### EXAMPLE 2

### Dichroic Mirror Coating

| Si₃N₄ | TiO₂ | Si | | | | |
|---|---|---|---|---|---|---|
| (Angstroms) | (Angstroms) | (Angstroms) | T (%) | Rf (%) | a | b |
| 260 | 280 | 253 | 18.7 | 60 | 0.3 | 1.9 |

### EXAMPLE 3

### Dichroic Mirror Coating

| Si₃N₄ | TiO₂ | Si | | | | |
|---|---|---|---|---|---|---|
| (Angstroms) | (Angstroms) | (Angstroms) | T (%) | Rf (%) | a | b |
| 240 | 280 | 253 | 18.4 | 57.3 | 0.5 | 2.9 |

### EXAMPLE 4

### Dichroic Mirror Coating

| Si₃N₄ | TiO₂ | Si | | | | |
|---|---|---|---|---|---|---|
| (Angstroms) | (Angstroms) | (Angstroms) | T (%) | Rf (%) | a | b |
| 200 | 280 | 253 | 18.3 | 58 | 0.4 | 3.3 |

### EXAMPLE 5

### Dichroic Mirror Coating

| Si₃N₄ | TiO₂ | Si | | | | |
|---|---|---|---|---|---|---|
| (Angstroms) | (Angstroms) | (Angstroms) | T (%) | Rf (%) | a | b |
| 200 | 280 | 260 | 18.1 | 58 | 0.3 | 3.3 |

### EXAMPLE 6

### Dichroic Mirror Coating

| Si₃N₄ | TiO₂ | Si | | | | | |
|---|---|---|---|---|---|---|---|
| (Ang- | (Ang- | (Ang- | NbTi | | | | |
| stroms) | stroms) | stroms) | (Angstroms) | T (%) | Rf (%) | a | b |
| 200 | 280 | 141 | 119 | 17.1 | 59.4 | −0.9 | 1.3 |

### EXAMPLE 7

### Dichroic Mirror Coating

| Si₃N₄ | TiO₂ | Si | | | | | |
|---|---|---|---|---|---|---|---|
| (Ang- | (Ang- | (Ang- | NbTi | | | | |
| stroms) | stroms) | stroms) | (Angstroms) | T (%) | Rf (%) | a | b |
| 200 | 240 | 141 | 119 | 16 | 60 | −1.1 | 0.8 |

### EXAMPLE 8

### Dichroic Mirror Coating

| Si₃N₄ | TiO₂ | Si | | | | | |
|---|---|---|---|---|---|---|---|
| (Ang- | (Ang- | (Ang- | NbTi | | | | |
| stroms) | stroms) | stroms) | (Angstroms) | T (%) | Rf (%) | a | b |
| 200 | 240 | 125 | 119 | 17.2 | 59 | −1.1 | 0.2 |

### EXAMPLE 9

### Dichroic Mirror Coating

| Si₃N₄ | TiO₂ | Si | | | | | |
|---|---|---|---|---|---|---|---|
| (Ang- | (Ang- | (Ang- | NbTi | | | | |
| stroms) | stroms) | stroms) | (Angstroms) | T (%) | Rf (%) | a | b |
| 240 | 240 | 125 | 105 | 18.9 | 58 | −1.2 | −0.1 |

### EXAMPLE 10

### Dichroic Mirror Coating

| Si₃N₄ | TiO₂ | Si | | | | | |
|---|---|---|---|---|---|---|---|
| (Ang- | (Ang- | (Ang- | NbTi | | | | |
| stroms) | stroms) | stroms) | (Angstroms) | T (%) | Rf (%) | a | b |
| 200 | 240 | 105 | 125 | 19.4 | 48 | −1.1 | −1.9 |

### EXAMPLE 11

### Dichroic Mirror Coating

| Si₃N₄ | TiO₂ | Si | NbTi | | | | |
|---|---|---|---|---|---|---|---|
| (Angstroms) | (Angstroms) | (Angstroms) | (Angstroms) | T (%) | Rf (%) | a | b |
| 200 | 240 | 125 | 105 | 18 | 58 | −1.3 | −0.3 |

The NbTi film in the preceding examples was deposited as a mixture of about 50% niobium and about 50% titanium. This film can be sputtered from a compound NbTi sputtering target having desired relative percentages of Nb and Ti. Alternatively, this film can be co-sputtered from two adjacent targets (e.g., dual rotatable targets) where on target is metallic titanium and the other target is metallic niobium. As noted above, this film can be deposited by any method described in U.S. patent application Ser. No. 10/123,032.

The titanium dioxide films in the preceding examples can be deposited by sputtering a metallic titanium target in a reactive oxidizing atmosphere. In another method, though, this film is deposited using a target having sputterable target material of substoichiometric titanium oxide (TiOₓ, where x is less than 2). This film can be deposited by any method described in U.S. Pat. Nos. 6,468,402, 6,511,587, and 6,461,686, the entire contents of each of which are incorporated herein by reference.

While various embodiments of the invention have been described, it should be understood that various changes, adaptations and modifications may be made therein without departing from the spirit of the invention and the scope of the appended claims.

What is claimed is:

1. A LCD comprising a mirror including a substrate having a first surface and a second surface and carrying one or more dichroic mirror coatings, the LCD or mirror being selectively viewable from the first surface side.

2. The LCD of claim 1, wherein the mirror is larger than an image created by the LCD when the LCD is switched on.

3. The LCD of claim 1, wherein the LCD is viewable when it is switched on, and the mirror is viewable when the LCD is switched off.

4. The LCD mirror claim 1, wherein the dichroic mirror coating includes a base layer and a metal oxide film layer.

5. The LCD mirror of claim 4, wherein the base layer includes silicon nitride and the metal oxide layer includes titanium oxide.

6. The LCD mirror of claim 1, wherein the dichroic mirror coating is carried on the first surface.

7. The LCD mirror of claim 1, wherein the dichroic mirror coating is carried on the second surface.

8. The LCD mirror of claim 1, wherein the dichroic mirror coating includes a reflection enhancing coating.

9. The LCD mirror of claim 8, wherein the reflection enhancing coating includes niobium and titanium.

10. The LCD mirror of claim 1, further including a protective overcoat.

11. The LCD mirror of claim 10, wherein the protective overcoat includes silicon.

12. The LCD mirror of claim 1, wherein one or more functional coatings is carried on the first surface.

13. The LCD mirror of claim 12, wherein the one or more functional coatings exhibits self-cleaning properties.

14. The LCD mirror of claim 13, wherein the functional coating comprises silica.

15. The LCD mirror of claim 12, wherein the one or more functional coatings includes a photocatalytic coating.

16. The LCD mirror of claim 15, wherein the photocatalytic coating comprises titanium oxide.

17. The LCD mirror of claim 1, wherein the LCD is able to display television images.

18. The LCD mirror of claim 17, wherein the LCD is able to display color images.

19. The LCD mirror of claim 1, further comprising one or more dichroic coatings and one or more functional coatings applied to the substrate with sputter up/sputter down techniques.

20. A LCD comprising a mirror including a substrate having a first surface and a second surface and carrying one or more dichroic mirror coatings including a base layer and a metal oxide film layer and one or more functional coatings, the LCD or mirror being selectively viewable from the first surface side.

21. The LCD mirror of claim 20, wherein the base layer includes silicon nitride and the metal oxide layer includes titanium oxide.

22. The LCD mirror of claim 20, wherein the one or more functional coatings exhibits self-cleaning properties.

23. The LCD mirror of claim 22, wherein the functional coating comprises silica.

24. The LCD mirror of claim 20, wherein the one or more functional coatings includes a photocatalytic coating.

25. The LCD mirror of claim 24, wherein the photocatalytic coating comprises titanium oxide.

26. A method of making a LCD mirror comprising providing a dual direction sputtering apparatus and a substrate, sputtering a functional coating onto a first side of the substrate from a first direction, sputtering a dichroic mirror coating onto a second side of the substrate from a second direction, and functionally connecting a LCD to the second side of the substrate.

27. The method of claim 26, wherein the dichroic mirror coating includes a base layer and a metal oxide film layer.

28. The method of claim 27, wherein the base layer includes silicon nitride and the metal oxide layer includes titanium oxide.

29. The method of claim 26, wherein the dichroic mirror coating is sputtered on the first surface.

30. The method of claim 26, wherein the dichroic mirror coating is sputtered on the second surface.

31. The method of claim 26, wherein the dichroic mirror coating includes a reflection enhancing coating.

32. The method of claim 31, wherein the reflection enhancing coating includes niobium and titanium.

33. The method of claim 26, further including a protective overcoat.

34. The method of claim 33, wherein the protective overcoat includes silicon.

35. The method of claim 26, wherein one or more functional coatings is sputtered on the first surface.

36. The method of claim 35, wherein the one or more functional coatings exhibits self-cleaning properties.

37. The method of claim 35, wherein the functional coating comprises silica.

38. The method of claim 35, wherein the one or more functional coatings includes a photocatalytic coating.

39. The method of claim 38, wherein the photocatalytic coating comprises titanium oxide.
